(19) United States
(12) Patent Application Publication
(10) Pub. No.: US 2003/0188066 A1
(43) Pub. Date: Oct. 2, 2003

(54) Method and apparatus to allow an external system management controller to trigger an OS controlled shutdown of a pc system through the system management bus

(76) Inventors: Atul Kwatra, Chandler, AZ (US); John P. Lee, Tempe, AZ (US); Aniruddha P. Joshi, Chandler, AZ (US)

Correspondence Address: KENYON & KENYON, Suite 600, 333 W. San Carlos Street, San Jose, CA, 95110-2711, US

(21) Appl. No.: 10/107,254

(22) Filed: Mar. 28, 2002

(51) Int. Cl. G06F 9/48

(52) U.S. Cl. 710/260

(57) ABSTRACT

Embodiments of the present invention provide a method and apparatus for receiving an input command over a system management bus, and, in response, simulating an existing signal which, when present, generates an interrupt. The interrupt, when received by the processor, triggers an operating system controlled shutdown of the computer system.

### TECHNICAL FIELD

The present invention relates to computer systems. More specifically, the present invention relates to a method and apparatus for generating an interrupt.

### BACKGROUND OF THE INVENTION

A typical computer system consists of several basic components, including a central processor, volatile and non-volatile memory, and various peripheral devices, including graphics controller(s), mass storage devices, and input/output devices. A chipset connects these computer system components together, and manages the flow of information between them. Several different communications protocols may be used by the computer system, including, for example, Peripheral Component Interconnect (PCI, Version 2.1), Small Computer System Interface (SCSI-2, ANSI X3.131-1994), Universal Serial Bus (USB, Version 2.0), Firewire (IEEE 1394-1995 Standard for a High Performance Serial Bus), etc.

Historically, computer system chipsets use a Northbridge/Southbridge architecture, in which the functionality of the chipset is apportioned between two basic chips, or components, a Northbridge chip and a Southbridge chip, connected via a PCI bus. The Northbridge chip connects the central processor to main/secondary memory, graphics controller(s), and the PCI bus, while the Southbridge chip connects all the other Input/Output (I/O) devices to the PCI bus. The I/O devices are indirectly connected to the central processor via the PCI bus and the Host-PCI Bridge on the Northbridge chip. Thus, the Northbridge/Southbridge architecture suffers from a data throughput limitation governed by PCI bus bandwidth, as well as a high cost due to the complexity associated with the amount of component integration on these two chips.

An improved chipset addressing these deficiencies, developed by the Intel Corporation of Santa Clara, Calif., uses an accelerated hub architecture. In this chipset, the functionality of the traditional Northbridge and Southbridge chips is divided among three basic components, the Memory Controller Hub (MCH), the I/O Controller Hub (ICH), and the Firmware Hub (FWH). These hubs are connected using a high-speed, proprietary data bus, (hub bus), rather than the PCI bus. As the name suggests, the ICH provides I/O functionality similar to that residing in the Southbridge chip, and may include modular components connected internally using a variety of internal buses. The ICH may also include various external bus interfaces, such as, for example, a PCI bus interface, or a system management bus (SMBus, Version 2) interface.

Originally, the SMBus was designed to communicate with a variety of power-related components, including, for example, batteries, LCD contrast and backlight controllers, power plane switches, etc. However, current implementations of ICH devices support only limited, command-based shutdown mechanisms over SMBus, including, for example, a hard reset and an unconditional power down. These severe procedures do not provide a graceful, controlled shutdown of the computer system, and may result in a detrimental loss of system state information and critical data.

### BRIEF DESCRIPTION OF THE DRAWINGS

FIG. 1 is a computer system block diagram, according to an embodiment of the present invention.

FIG. 2 is a controller block diagram, according to an embodiment of the present invention.

FIG. 3 illustrates a method for generating an interrupt, according to an embodiment of the present invention.

### DETAILED DESCRIPTION

Embodiments of the present invention provide a method, apparatus, and system for receiving an input command over a system management bus, and, in response, simulating an existing signal which, when present, generates an interrupt. The interrupt, when received by the processor, triggers an operating system controlled shutdown of the computer system.

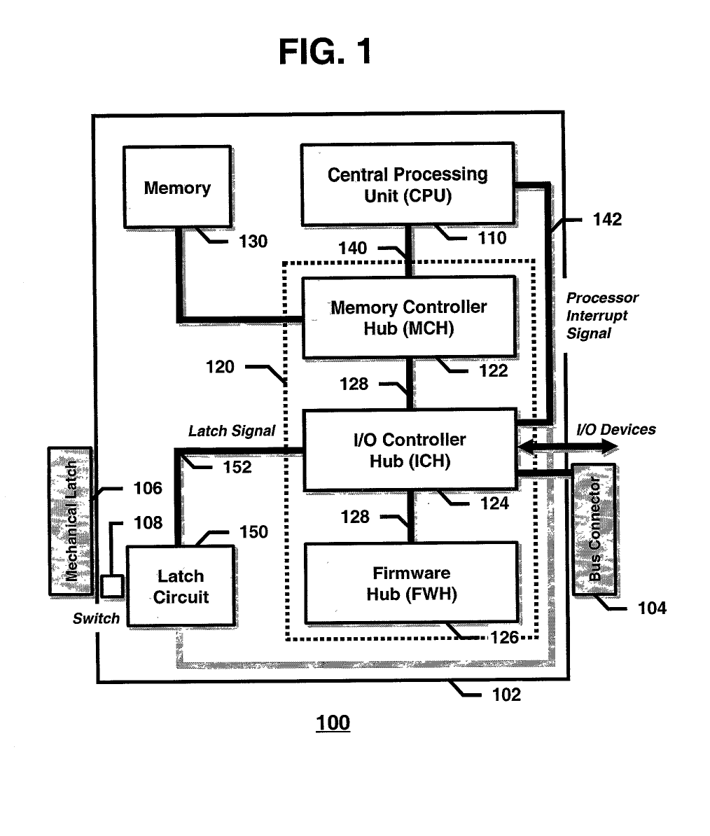

FIG. 1 is a computer system block diagram according to an embodiment of the present invention.

The computer system may include a central processing unit (CPU) 100 (hereinafter processor 100) having a processor interrupt input 105, a memory controller hub (MCH) 110, an I/O controller hub (ICH) 120, and a firmware hub (FWH) 130, as well as a thermal circuit 150. Processor 100 may be coupled to MCH 110 via a host bus 160. MCH 110, ICH 120, and FWH 130 may be coupled via a hub bus 170.

ICH 120 may include a hub interface 122, an SMBus interface 124, a thermal signal input 126, and a processor interrupt output 128. ICH 120 may receive commands from an external system management controller (SMC) 140 over SMBus 123 via SMBus interface 124, and a thermal signal 125 from thermal circuit 150 via thermal signal input 126. ICH 120 may also provide a processor interrupt signal 127 via processor interrupt output 128 to processor interrupt input 105. In an embodiment, ICH 120 may contain several internal buses and components, including, for example, an SMBus slave module, a hublink module, peripheral device interfaces, PCI bridges, PCI configuration registers, and an SMBus Host Controller.

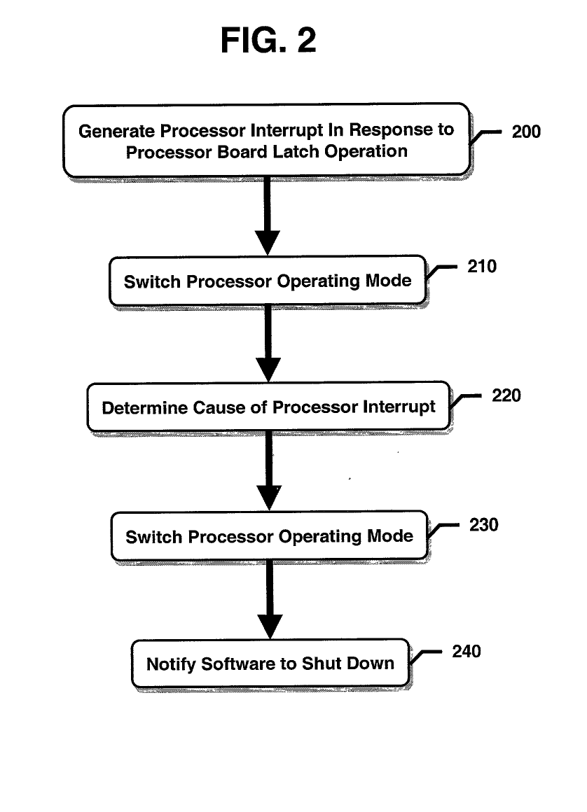

FIG. 2 is a controller block diagram according to an embodiment of the present invention. In an embodiment, controller 120 may be any device that connects external I/O devices to an internal computer system bus, such as, for example, a PCI bus. Controller 120 may be, for example, a Southbridge chip connecting an external SMBus to an internal PCI bus.

In another embodiment, controller 120 may be, for example, ICH 120 connecting external SMBus 123 to hub bus 170. Controller 120 may include arbitration logic 200 coupled to SMBus interface 124, NAND gate 210 coupled to arbitration logic 200 via command signal 202 and arbitration signal 204, thermal signal 125 coupled to thermal signal input 126, AND gate 220 coupled to thermal signal 125 and output 212 of NAND gate 21 0, and status register logic 230 coupled to output 222 of AND gate 220. Controller 120 may also include status register 240 having thermal status bit 242, interrupt logic 250 coupled to status register 240 and interrupt signal output 128, and hub interface logic 260 coupled to status register 240 and hub interface 122. In an embodiment, command signal 202, arbitration signal 204, output 212, thermal signal 125, and output 222 may be logic level signals; command signal 202 and arbitration signal 204 may be, for example, active high signals, while output 212, thermal signal 125, and output 222 may be active low signals. One skilled in the art will recognize that the functionality of these signals and logic gates may be embodied in different ways, or, alternatively, within firmware or software modules.

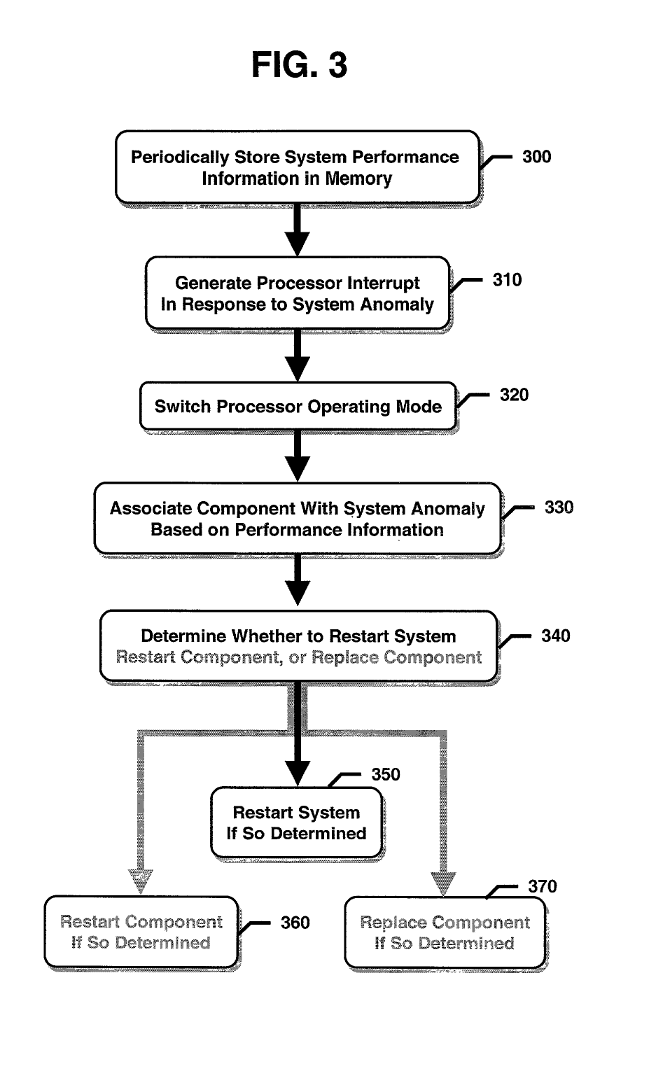

FIG. 3 illustrates a method for generating an interrupt, according to an embodiment of the present invention.

A command may be received 300 from an external system management controller over a system management bus. The command generally indicates that an existing signal within controller 120 may be simulated. The existing signal, when present, generates a processor interrupt that triggers an operating system controlled shutdown of the computer system. For example, the command may indicate that thermal signal 125 should be simulated.

In an embodiment, the external controller may be, for example, SMC 140, and the command may be received over SMBus 123 by controller 120 via SMBus interface 124. Controller 120 may include logic to receive and process the command. For example, this logic may be embodied within arbitration logic 200, or, alternatively, within other SMBus command processing logic within controller 120. The command may be, for example, an SMBus write command with a new write command code (e.g., command code 0×09).

A command signal may be activated 310 in response to receiving the command. In an embodiment, arbitration logic 200 may activate command signal 202. In an alternative embodiment, other SMBus command processing logic within controller 120 may activate command signal 202.

Access to a thermal status bit may be arbitrated 320 in response to receiving the command. In an embodiment, arbitration logic 200 may determine whether other components within controller 120 are attempting to access thermal status bit 242, such as, for example, the power management unit (not shown). If the arbitration is successful, i.e., if no other components are currently attempting to read or write to thermal status bit 242, then arbitration logic 200 may activate 330 arbitration signal 204. Command signal 202 and arbitration signal 204 may be input to NAND gate 210.

If both command signal 202 and arbitration signal 204 are active 340, output 212 of NAND gate 210 may be an active signal. Conversely, if either command signal 202 or arbitration signal 204 are not active, output 212 of NAND gate 210 may be an inactive signal. In an embodiment, command signal 202, arbitration signal 204, and output 212 may be logic level signals; command signal 202 and arbitration signal 204 may be, for example, active high signals, while output 212 may be an active low signal. Output 212 may simulate 350 an existing thermal signal, which may be, for example, thermal signal 125.

A thermal signal may be received 360 from a thermal circuit. In an embodiment, controller 120 may receive thermal signal 125 from thermal circuit 150 over thermal signal input 126. Thermal signal 125 may represent, for example, an over-temperature condition, detected by thermal circuit 150, within the computer system. Output 212 and thermal signal 125 may be input to AND gate 220.

If either output 212 or thermal signal 125 are active 370, output of 222 of AND gate 220 may be an active signal. Conversely, if both output 212 and thermal signal 125 are not active, output 222 of AND gate 220 may be an inactive signal. In an embodiment, output 212, thermal signal 125, and output 222 are logic level signals which may be, for example, active low signals. Output 222 of AND gate 220 may be provided to status register logic 230.

A thermal status bit may be set 380 in response to an active signal. In an embodiment, status register logic 230 determines whether output 222 is active, and sets thermal bit 242 in status register 240 accordingly. For example, thermal bit 242 may be set to logical ‘0’ to indicate an inactive status and logical ‘1’ to indicate an active status; an active status may indicate that a processor interrupt may be generated.

A processor interrupt may be generated 390 based on the value of a bit within a status register. In an embodiment, interrupt logic 250 may detect when thermal status bit 242 is set to an active status and may generate a processor interrupt 127 on interrupt output 128. Processor interrupt 127 may be provided to processor 100 via interrupt input 105. Processor interrupt 127 may be, for example a system control interrupt (SCI) or a system management interrupt (SMI). Upon detection of processor interrupt 127 on interrupt input 105, processor 100 may trigger an operating system controlled shutdown of the computer system.

There are many well-known mechanisms for detecting and processing processor interrupt signals that may be employed. In an embodiment, processor 100 may invoke an operating system interrupt handler driver (OS driver) associated with processor interrupt 127; the OS driver may direct the shutdown of the computer system. Alternatively, the OS driver may invoke another operating system process or routine that controls the shutdown of the computer system. The shutdown process may include, for example, flushing secondary memory components (e.g., L1 or L2 caches), saving system and application data stored in random access memory (RAM) to a non-volatile storage device (e.g., a hard disk), halting the execution of application programs and system software components, terminating network connections, powering down peripheral devices, etc.

In another embodiment, the OS driver may send a request to controller 120, over host bus 160, hub bus 170, and hub bus interface 122, to determine the source of processor interrupt 262. Controller 120 may respond to the request, over hub bus interface 122, with the source of processor interrupt 127. If the source matches a predetermined criterion, the OS driver may then direct the shutdown of the computer system.

In a further embodiment, the OS driver may send a request to controller 120, over host bus 160 and hub bus 170, to read the contents of status register 240. Hub interface logic 260 may receive the request, over hub bus interface 122, and, in response, determine the contents of status register 240. Hub interface logic 260 may respond to the request by sending the contents of status register 240 to processor 100 over hub bus interface 122. Alternatively, Hub interface logic 260 may send only the value of thermal status bit 242 to processor 100. OS driver may then examine the contents of general purpose status register 240 to determine the value of thermal status bit 242. If thermal status bit 242 is active, then the OS driver may direct the shutdown of the computer system, or alternatively, the OS driver may invoke another operating system process or routine that controls the shutdown of the computer system.

In another embodiment, processor interrupt 127 may be an SMI and may invoke a processor context switch to a different operating mode, such as, for example, system management mode (SMM). While in SMM, processor 100 may execute SMI handler code to determine the source of the SMI, which may include, for example, polling controller 120 to determine the contents of status register 240, including thermal status bit 242. If thermal status bit 242 is determined to be active, SMM may trigger a processor context switch which reloads the saved context and resumes execution of the interrupted application or operating system program or task. An indication may be provided, by SMM to the operating system, that an operating system controlled shutdown of the computer system should then commence. The indication may be, for example, a predetermined value in a predetermined location in memory 106.

Several embodiments of the present invention are specifically illustrated and described herein. However, it will be appreciated that modifications and variations of the present invention are covered by the above teachings and within the purview of the appended claims without departing from the spirit and intended scope of the invention.

What is claimed is:

1. A method for generating an interrupt in a computer system, comprising:
receiving an input command over a system management bus; and
in response to the input command, simulating an existing signal, which, if active, generates the interrupt.

2. The method of claim 1, wherein:
the input command is a system management bus command to set a thermal status bit, received from an external system management controller; and
the interrupt is a system management interrupt.

3. The method of claim 2, further comprising:
detecting the system management interrupt;
determining whether the thermal status bit is set; and
if the thermal status bit is set, triggering an operating system controlled shutdown of the computer system.

4. The method of claim 1, wherein the existing signal is a thermal signal.

5. The method of claim 4, further comprising:
setting a thermal status bit in a status register if the thermal signal is active; and
generating an interrupt if the thermal status bit is set.

6. The method of claim 5, wherein said simulating includes:
arbitrating for access to the thermal status bit;
if the arbitrating is successful, activating a simulated thermal signal; and
setting the thermal status bit when the simulated thermal signal is active.

7. The method of claim 6, wherein said activating the simulated thermal signal includes:
activating a command signal in response to the input command;
activating an arbitration signal if said arbitrating is successful; and
inputting the command signal and the arbitration signal to a NAND logic gate, wherein the output of the NAND logic gate is the simulated thermal signal.

8. The method of claim 7, further comprising:
inputting the thermal signal and the simulated thermal signal to an AND logic gate; and
setting the thermal status bit if the output of the AND logic gate is active.

9. A controller for a computer system, comprising:
an interface to a system management bus;
an output for an interrupt; and
logic, coupled to the system management bus interface and the interrupt output, responsive to an input command received over the system management bus interface to simulate an existing signal which, if active, generates the interrupt.

10. The controller of claim 9, wherein:
the input command is a system management bus command, received from an external system management bus controller, to set a thermal status bit; and
the interrupt is a system management interrupt.

11. The controller of claim 9, wherein the logic includes:
arbitration logic, having a first output and a second output, responsive to the input command to arbitrate for access to a status bit, associated with the existing signal, in a status register; and
a NAND logic gate, having a first input coupled to the first arbitration logic output, a second input coupled to the second arbitration logic output, and an output to simulate the existing signal.

12. The controller of claim 11, wherein the existing signal is a thermal signal and the status bit is a thermal status bit.

13. The controller of claim 12, further comprising an input, coupled to the logic, for the thermal signal.

14. The controller of claim 13, wherein the logic includes:
an AND logic gate having a first input coupled to the thermal signal input, a second input coupled to the output of the NAND logic gate, and an output; and
status bit logic, coupled to the output of the AND logic gate, to set the thermal status bit in the status register.

15. The controller of claim 14, wherein the logic includes interrupt logic, coupled to the status register, to detect the thermal status bit and, if set, to generate the processor interrupt.

16. The controller of claim 15, further comprising an interface to a host bus, wherein the logic includes host interface logic, coupled to the host bus interface, responsive to a request, received over the host bus, to send the contents of the status register over the host bus.

17. The controller of claim 16, wherein the contents of the status register includes the thermal status bit.

18. A computer system, comprising:
a processor having an operating system;
a system management bus coupled to an external system management controller; and
a controller, coupled to the system management bus and the processor, responsive to a command received over the system management bus to simulate an existing signal which, if active, generates an interrupt to the processor.

19. The computer system of claim 18, wherein the interrupt is a system management interrupt and the processor includes a system management mode responsive to the system management interrupt to invoke an operating system controlled shutdown of the computer system.

20. The computer system of claim 18, wherein the existing signal is a thermal signal and the controller includes:
an input for the thermal signal;
arbitration logic having a first output and a second output, coupled to the system management bus interface, to arbitrate for access to a thermal status bit in a status register; and
a NAND gate having a first input coupled to the first arbitration logic output, a second input coupled to the second arbitration logic output, and an output to simulate the thermal signal.

21. The computer system of claim 20, wherein the controller includes:
an output for the interrupt;
an AND logic gate, coupled to the thermal signal input and the output of the NAND logic gate;
status bit logic, coupled to the output of the AND logic gate, to set the thermal status bit; and
interrupt logic, coupled to the status register and the interrupt output, to generate the interrupt if the thermal status bit is set.

22. The computer system of claim 21, further comprising a host bus, coupled to the processor and the controller, wherein the controller is responsive to a request received over the host bus to send the contents of the status register over the host bus.

23. The computer system of claim 22, wherein the contents of the status register include the thermal status bit.

24. A machine-readable medium in which is stored one or more instructions adapted to be executed by a processor, the instructions which, if executed, configure the processor to:
receive an input command over a system management bus; and
in response to the input command, simulate an existing signal, which, if active, generates the interrupt.

25. The machine-readable medium of claim 24, wherein:
the input command is a system management bus command to set a thermal status bit, received from an external system management controller; and
the interrupt is a system management interrupt.

26. The machine-readable medium of claim 25, wherein the instructions, if executed, further configure the processor to:
detect the system management interrupt;
determine whether the thermal status bit is set; and
if the thermal status bit is set, trigger an operating system controlled shutdown of the computer system.

27. The machine-readable medium of claim 24, wherein the existing signal is a thermal signal.

28. The machine-readable medium of claim 27, wherein the instructions, if executed, further configure the processor to:
set a thermal status bit in a status register if the thermal signal is active; and
generate an interrupt if the thermal status bit is set.

29. The machine-readable medium of claim 28, wherein said simulate operation further configures the processor to:
arbitrate for access to the thermal status bit;
if the arbitration is successful, activate a simulated thermal signal; and
set the thermal status bit if the simulated thermal signal is active.

30. The machine-readable medium of claim 29, wherein said activate operation further configures the processor to:
activate a command signal in response to the input command;
activate an arbitration signal if said arbitration is successful; and
input the command signal and the arbitration signal to a NAND logic module, wherein the output of the NAND logic module is the simulated thermal signal.

31. The machine-readable medium of claim 30, wherein the instructions, if executed, further configure the processor to:
input the thermal signal and the simulated thermal signal to an AND logic module; and
set the thermal status bit if the output of the AND logic module is active.
